(19) United States
(12) Patent Application Publication
(10) Pub. No.: US 2015/0042624 A1
(43) Pub. Date: Feb. 12, 2015

(54) STYLUS

(71) Applicant: MICRO CO., LTD., Tokyo (JP)

(72) Inventor: Keito Hashimoto, Fukushima (JP)

(21) Appl. No.: 14/234,762

(22) PCT Filed: Jan. 24, 2013
(86) PCT No.: PCT/JP2013/051416

§ 371 Date: Jan. 24, 2014

(30) Foreign Application Priority Data
Feb. 29, 2012 (JP) 2012-043634

(51) Int. Cl. G06F 3/0354

(52) U.S. Cl. CPC G06F 3/03545
USPC 345/179

(57) ABSTRACT

Provided is a capacitive stylus which has, at the tip, an electrically conductive pad that has been made less deformable and that recovers the original shape immediately when the electrically conductive pad is released from a screen.

A stylus body (1) has an electrically conductive core (4), and the electrically conductive core (4) has a hollow electrically conductive pad (7) at the tip. At an outside peripheral portion, the electrically conductive pad (7) engages with a pad holder (10) and a closing unit (11).

The electrically conductive pad (7) accommodates a pressing body (12) in the inside. The pressing body (12) presses the inner surface of the electrically conductive pad (7) toward the outside by using a spring (13). Even if the electrically conductive pad (7) has a depression, the electrically conductive pad recovers the original shape immediately due to the pressing body (12).

### FIELD OF THE INVENTION

The present invention relates to a stylus for carrying out instruction or operation in an electrostatic system by touch or drag on a screen with a tip of the stylus.

### BACKGROUND INFORMATION

In recent years, portable electronic devices, etc. of a type of carrying out operation on screen with a fingertip or a special-purpose stylus have been used, and various types of styluses for carrying out input of signals in an electrostatic system have been proposed (for example, Patent Document 1).

As one of the styluses of this type, a stylus has been known in which a pad formed into a hollow structure with a conductive rubber is disposed at the front end of the stylus so as not to damage the screen and the pad is configured to electrically couple with a stylus body. However, this pad is easily dented when it touches the screen and is pressed against the screen in use, and, there is a risk that it may be deformed into a dented shape and may not recover the original shape when continuously used. For example, ones indicated in the above Patent Document 1 are quite easily deformable as a whole, since an elastic material such as rubber, urethane or spongy or a filling material made of a gel-like material is disposed, and its surface is covered with a thin conductive rubber of 0.1 mm to 0.4 mm in thickness, and the hardness of this elastic material or filling material is set to be lower than the hardness of the conductive rubber. Accordingly, the conductive rubber and the elastic material or filling material are easily dented only when it touches the screen and is lightly pressed against the screen, and may remain deformed in the dented shape and possibly fail to recover the original shape when used for a long period of time, and then accurate touch on the screen cannot be made next time. In addition, in a case of a gel-like material, it does not instantaneously recover the original shape when the conductive rubber is detached from the screen, and it takes time to recover the original shape, and the deformed condition remains and accurate touch cannot be made next time. Further, in the conventional electrostatic system, it is required to form the stylus body as a whole or its gripping portion with a conductive material to allow electrical coupling with the conductive rubber, and therefore such stylus cannot be obtained with low costs.

### PRIOR ART DOCUMENTS

Patent Document 1: Japanese Patent No. 4142776 (paragraphs 0007 and 0012)

### SUMMARY OF THE INVENTION

### Problems to be Solved by the Invention

It is an object of the present invention to provide a stylus of an electrostatic system, which will not possibly damage the screen and, the pad of which is not deformed even when it is used for a long period of time, and to provide a stylus of an electrostatic system in which the stylus body can be constituted at low costs with a nonconductive material.

### Means of Solving the Problems

The present invention provides a stylus comprising a stylus body, a conductive core disposed on the stylus body, a hollow conductive pad projected from the front end of the conductive core, a pressing body accommodated at the inside of the conductive pad, and a spring urging the pressing body against the inner surface of the conductive pad; and the above problems can be solved by this stylus.

The present invention further provides a stylus in which the conductive pad and the conductive core are integrally formed in a double mold fashion, and the conductive core is inserted into the stylus body which is made of a nonconductive material. Further, on the outer periphery at the front end of the conductive pad, a pad holder is fitted, and on the outer periphery of the pad holder, a closing unit attached to the stylus body is fitted.

### Effects of the Invention

The stylus of the present invention is constructed as above, namely, the stylus comprises a stylus body, a conductive core disposed on the stylus body, a hollow conductive pad projected from the front end of the conductive core, a pressing body accommodated at the inside of the conductive pad, and a spring urging the pressing body against the inner surface of the conductive pad; and therefore in use, when the front end of the conductive pad touches the screen, the conductive pad is a little dented, but by the urging force of the pressing body with the spring, the pad is positively pressed from the inside, and when the front end is detached from the screen, the pad instantaneously recovers its original state. Accordingly, the original shape can be kept even when used for a long period of time, and the front end of the pad can point the desired position on the screen, and does not bring about difficulty in use due to deformation happened in conventional ones.

Further, if the conductive pad and the conductive core are integrally formed in a double mold fashion, the production can be made easily, and in addition, the present inventors have confirmed that even when the conductive core is inserted into the stylus body made of a nonconductive material, it is possible to carry out operation on the screen via the conductive pad in an electrostatic system. Accordingly, the stylus body can be constructed without using expensive conductive plastic materials conventionally used, and the stylus can be produced at low costs as a whole. Moreover, the conductive pad is connected to a connecting portion of the conductive core, the pad holder is fitted on the outer periphery of the pad which is fitted to the connecting portion, and the closing unit attached to the stylus body is fitted on the pad holder to hold a basal part of the conductive pad, whereby the connecting portion of the conductive pad can be securely supported by the surrounding and the front end is not easily detached even when it is swung transversely. If the connecting portion, pad holder and closing unit are formed in such a tapered shape that the outer diameter is reduced toward the front end, the conductive pad can be more firmly held.

### BRIEF DESCRIPTION OF THE DRAWINGS

FIG. 1 is a cross-sectional view showing an example of the present invention.

FIG. 2 is an explanatory view showing the state in use.

FIG. 3 is a cross-sectional view showing another example.

### DETAILED DESCRIPTION OF THE PREFERRED EMBODIMENTS

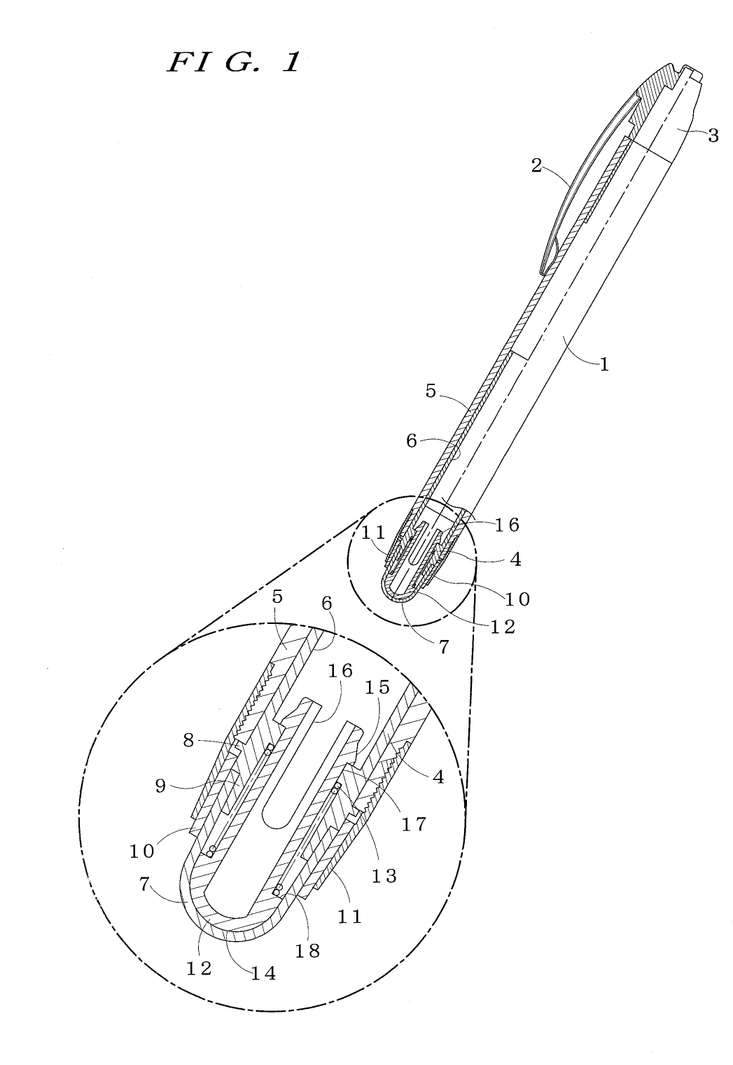

With reference to FIG. 1, the stylus of the present invention has a stylus body 1 of a hollow barrel-shape, and at its rear end, a rear cap 3 having a clip 2 is fitted, and at its front end, a tubular conductive core 4 is inserted and fixed in a hermetically fitted condition. The stylus body 1 may be made of a conductive material as a whole, but in the example shown in this figure, it is made of a nonconductive plastic material, and the conductive core 4 is inserted so that a tubular body 6 of the conductive core 4 will be positioned at the inside of a part 5 which is gripped by hand, and a conductive pad 7 is disposed at the front end of the conductive core 4. Even if the stylus body 1 is made of a nonconductive material like this example, by letting the conductive pad 7 touch the screen while gripping the gripping part 5 of the stylus body 1, operation can be carried out on the screen by an electrostatic effect through the conductive core 4. In addition, the conductive core 4 may be incorporated into the stylus body 1 so that a part of the conductive core will be exposed to the outside (not shown).

At the front portion of the tubular body 6 of the conductive core 4, a flange 8 is formed, and the tubular body 6 is inserted into the stylus body 1 in a hermetically fitted condition until the flange 8 abuts on the front end of the stylus body 1. The stylus body 1 and the conductive core 4 may be integrally formed in a double mold fashion, and in this instance, the flange may be omitted. In FIG. 1, at the front portion of the flange 8, a taper-shaped connecting part 9 of which the outer diameter reduces toward the front end is disposed, and on the outer periphery of the connecting part 9, the conductive pad 7 of which the front end is formed into a spherical shape with a conductive rubber material is fitted. The conductive pad 7 and the conductive core 4 may be separately produced and then fitted, and these are preferably integrally formed in a double mold fashion.

On the outer periphery of the basal part of the conductive pad 7, a pad holder 10 is fitted to hold the conductive pad 7. The pad holder 10 is formed in a tapered shape of which the outer diameter of the front end reduces corresponding to the connecting part 9. Further, on the outer periphery of the pad holder 10, is fitted a closing unit 11 which is threadably attached to the front outer periphery of the stylus body 1 and of which the diameter reduces toward the front end. In this instance, the pad holder may be omitted so that the tapered closing unit will be directly fitted on the basal part of the conductive pad. Since the basal part of the conductive pad 7 is securely held via the tapered pad holder 10 and the tapered closing unit 11 as described above, it is not easily detached. As shown in the figure, the front end of the pad holder 10 projects toward the front portion from the front end of the conductive core 4 and has a length to surround the basal part of the conductive pad. Further, the front end of the closing unit 11 a little retracts from the front end of the pad holder 10 in such a state that it is threadably attached to the stylus body. By this structure, even if the conductive pad 7 is moved right and left while putting it in contact with the screen, peeling force is hardly exerted to the connecting part 9 of the conductive pad 7 and the conductive core 4, whereby detachment of the conductive pad 7 can be more securely prevented.

At the inside of the conductive pad 7, a pressing body 12 is accommodated. The pressing body 12 abuts on the inner surface of the conductive pad 7 by a spring 13 and presses the pad outwardly from the inside. In the example shown in FIG. 1, the pressing body 12 is made of a nonconductive plastic material having a hardness higher than that of the conductive pad 7 and formed into a tubular shape having a semi-spherical shaped pressing face 14 at its front end, and has a split portion 16 having locking pawls 15 formed at its rear portion, and the split portion 16 is inserted movably forward and backward into a through-hole 17 formed in the conductive core 4. And, the spring 13 is attached between a stepped portion 18 of the pressing body 12 and the front edge portion of the through-hole 17 so that the pad can move forward toward the front end until the locking pawl 15 abuts on the rear edge portion of the through-hole 17. In use, when load is exerted toward the rear side from the forward end, the pressing body 12 moves forward or backward against the spring 13. When the stylus is not used and the load is no longer exerted, the pressing body 12 is instantaneously returned to the advanced position by the action of the spring.

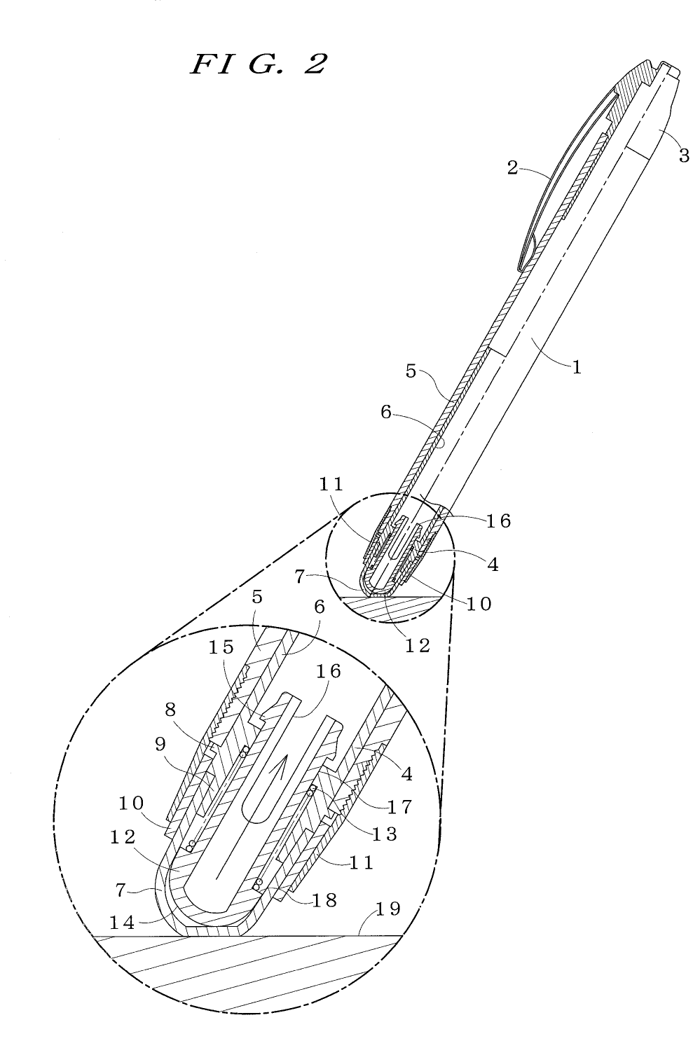

In the above structure, when the conductive pad 7 at the front end of the stylus shown in FIG. 1 is made to abut on a screen 19 as shown in FIG. 2, the part of the conductive pad 7 being in touch with the screen 19 is a little dented as shown in FIG. 2, but in this instance, since the conductive pad is pressed from the inside by the pressing body 12, the conductive pad 7 is not weakly deformed and it is possible to securely touch and drag on the desired positions on the screen. And, when the conductive pad 7 is detached from the screen 19, the conductive pad 7 instantaneously recovers the original shape by being forcibly pressed by the pressing body 12 which is pressed by the spring 13, by which the deformed condition is cleared.

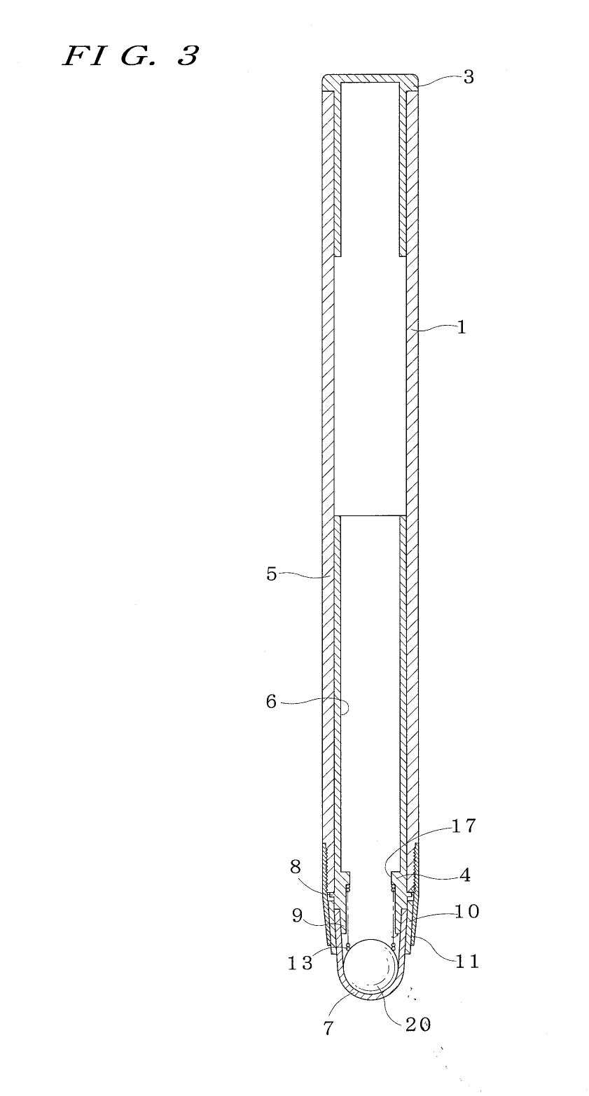

FIG. 3 shows another example. The basic structure thereof is the same as the above example, but the structure of the pressing body is different. In this example, the rear end of the stylus body 1 is blocked with a rear cap 3 having no clip, and at the front portion, a conductive core 4, a conductive pad 7, a pad holder 10 and a closing unit 11 are disposed like the above example. A pressing body 20 is formed in a spherical shape with a metallic material or a nonconductive plastic material which has a hardness higher than the conductive pad 7, and directly pressed by a spring 13 provided between the conductive core 4 and the pressing body 20. In this example as well, the stylus can be used like the above example, namely, when the conductive pad 7 is detached from the screen, the pad instantaneously recovers the original shape and no deformation remains.

### EXPLANATION OF SYMBOLS

1 Stylus body
4 Conductive core
6 Tubular body
7 Conductive pad
10 Pad holder
11 Closing unit
12 Pressing body
13 Spring
19 Screen
20 Pressing body

1. A stylus comprising a stylus body, a conductive core disposed on the stylus body, a hollow conductive pad projected from the front end of the conductive core, a pressing body accommodated at the inside of the conductive pad, and a spring urging the pressing body against the inner surface of the conductive pad.

2. The stylus according to claim 1, wherein the conductive pad and the conductive core are integrally formed in a double mold fashion.

3-10. (canceled)
